(19) United States
(12) Patent Application Publication
(10) Pub. No.: US 2016/0094018 A1
(43) Pub. Date: Mar. 31, 2016

(54) CIRCUIT ARRANGEMENT FOR SURGE PROTECTION IN DC SUPPLY CIRCUITS

(71) Applicant: DEHN + SÖHNE GMBH + CO.KG, Neumarkt (DE)

(72) Inventors: Peter IGL, Pyrbaum (DE); Ralph BROCKE, ILMENAU (DE)

(21) Appl. No.: 14/785,687

(22) PCT Filed: Mar. 27, 2014
(86) PCT No.: PCT/EP2014/056168

§ 371 Date: Oct. 20, 2015

(30) Foreign Application Priority Data
Apr. 22, 2013 (DE) 20 2013 101 705.1

(51) Int. Cl. H01T 4/16; H01T 4/02

(52) U.S. Cl. CPC H01T 4/16; H01T 4/02

(57) ABSTRACT

The invention relates to a circuit arrangement for surge protection in DC supply circuits of electronic components or devices, in particular telecommunication devices such as transmitting and receiving antennas and/or mobile radio systems. The circuit consists of a coarse protection series circuit comprising spark gaps or gas discharge tubes between the input terminals and of capacitors connected in parallel to the spark gaps or gas discharge tubes. Furthermore, at least one fine protection element is provided between the output terminals, and a decoupling impedance is mounted between the coarse protection series circuit and the fine protection element. According to the invention, the capacitance values of the capacitors are multiple times greater than the capacitance values of the gas discharge tubes or spark gaps, the inductance of the decoupling impedance being chosen such that, in the event of a current rise, a sufficient voltage drop is produced to switch through the spark gaps or gas discharge tubes before the load limit of the fine protection element is reached.

The invention relates to a circuit arrangement for overload protection in direct current supply circuits of electronic components or devices, particularly telecommunication devices such as transmitting and receiving antennas and/or mobile communication systems, comprising a coarse protection series connection of spark gaps or gas discharge arresters between the input terminals as well as capacitors connected in parallel to the spark gaps or gas discharge arresters, at least one fine protection element between the output terminals, and a decoupling impedance between the coarse protection series connection and fine protection element in accordance with the preamble of claim 1.

A control arrangement for the spark gaps of an overvoltage arrester is known from DE 25 47 604 A1. The control resistors in parallel with the spark gaps therein are able to affect the voltage drop over the individual spark gaps such that a first spark gap initially fires. By means of control resistors having exponents of varying magnitudes, a successive switching of the further spark gaps ensues in order to reduce the response voltage of the overall arrangement. The solution according to DE 25 47 604 A1 is to reduce the disadvantage of re-ignition which occurs in previously known arrangements when multiple overvoltage events follow in quick succession such that there is insufficient cooling of the spark gaps between the individual overvoltage events.

The spark gap able to carry lightning strike current according to DE 297 24 817 U1 starts from a plurality of spark gaps connected in series, wherein the spark gap consists of n part-gaps, their arc voltage being brought by their series connection to n-times the arc voltage value of one part-gap. With the exception of the part-gap first to respond upon a lightening strike, the part-gaps are connected with impedance with the objective of successive switching. The second and all further spark gaps according to DE 297 24 817 U1 are directly set at a common reference potential, particularly the free electrode of the last spark gap as reference electrode.

Overvoltage protection devices having the name of “Blitzduktor” are further known from the DEHN+SÖHNE GmbH+Co, KG company, Neumarkt, Germany. Such Blitzduktor BVT KKS ALD 75 or BVT ALD 36 overvoltage protection devices comprise gas discharge arresters connected in series with parallel-connected capacitors for the purpose of successive switching of the individual gas discharge arresters. The objective of the known arrester is to reduce the response voltage between the leads of a twisted pair. In the known overvoltage protection devices, the series connection of the spark gaps/gas discharge arresters achieves summation of the arc voltage such that the permissible operating voltage increases. If the sum of the arc voltage of the individual components is greater than the operating voltage, a discharge follows; i.e. a deactivating of the arrester independent of the current flowing upon the responding of the arrester.

Based on the foregoing, the invention thus addresses the task of specifying a further-developed circuit arrangement for overload protection in direct current supply circuits of electronic components or devices, particularly mobile communication system devices, which ensures the necessary overvoltage protection independent of operating or rated current. The invention hereby draws on the known concept of gas arresters in series connection and utilizes a thusly achieved arc voltage summation so as to enable discharging at higher nominal voltages. The inventive solution is to ensure a low voltage protection level of ≦100 V in order to protect the input circuit of current supplies or also of antennas and/or amplifiers in mobile communication systems. Inasmuch, the circuit to be established is to enable overvoltage protection for various different components in order to reduce installation efforts and costs.

This task of the invention is solved by the feature combination of claim 1, wherein the subclaims at the least constitute advantageous embodiments and further developments.

The series connection of gas discharge arresters or spark gaps, and the summation of the individual arc voltages thereby achieved, inventively results in a discharge of operating voltage up to the arc voltage summation without limiting the circuit arrangement to a maximum operating or fault current.

The capacitances (capacitors) connected in parallel to the gas discharge arresters achieves a control of the voltage distribution with the result of sequential gas discharge arrester connection. This thereby achieves a total circuit arrangement response voltage which corresponds to the response voltage of an individual gas discharge arrester.

The design of downstream fine protective circuitry on the output terminal is based on the arc voltage of the overall arrangement.

According to the invention, a very low decoupling impedance can be used to coordinate the overall arrangement coarse protection to fine protection since all that needs to be ensured is that there is a sufficient voltage drop in the current increase before reaching the load limit of the diodes employed as fine protection elements in order to connect the gas discharge arrester. In addition, the necessary current-carrying capacity of the fine protection reduces due to the intended function of the sequential connection of the coarse protection elements; i.e. the gas discharge arrester or the spark gaps. The decoupling impedance can be designed with view of low impedance values upon high operating currents.

The present invention thus considers a circuit arrangement for overload protection in direct current supply circuits of electronic components or devices, particularly telecommunication devices such as transmitting and receiving antennas and/or mobile communication systems, comprising a coarse protection series connection of spark gaps or gas discharge arresters between the input terminals as well as capacitors connected in parallel to the spark gaps or gas discharge arresters. At least one fine protection element is further arranged between the output terminals and a decoupling impedance is provided between the coarse protection series connection and the fine protection element.

In accordance with the invention, the capacitance values of the capacitors are many times greater than the capacitance values of the gas discharge arresters or spark gaps. As noted above, the inductance of the decoupling impedance is dimensioned such that when the current rises, there will be a large enough drop in voltage in order to connect the spark gaps or gas discharge arresters before the load limit of the fine protection element is reached.

The configuration thus connects a capacitor between each point of connection of the spark gaps or gas discharge arresters and the ground potential, wherein the ratio of the gas discharge arrester/spark gap capacitance values to the capacitor is essentially 1:100.

The gas discharge arresters have substantially the same response voltage so that upon a surge, the gas discharge arresters can be sequentially enabled.

In one preferential embodiment, the fine protection element consists of a series connection of diodes, particularly suppressor diodes or TVS diodes. The stand-off voltage of these series-connected diodes is thereby greater than the sum of the gas discharge arrester arc voltages.

The following will reference an embodiment as well as figures in describing the invention in greater detail.

Hereby shown are:

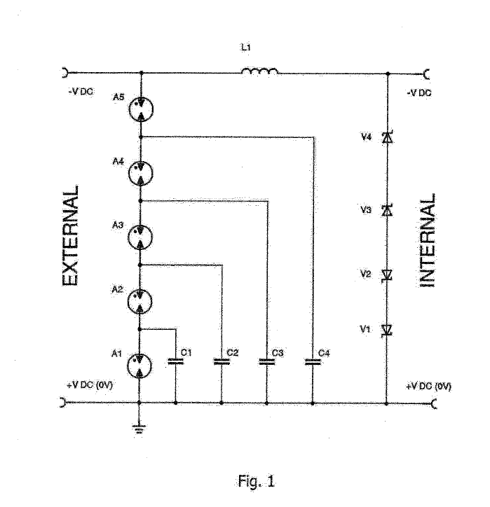

FIG. 1 an example circuit arrangement for an operating voltage of up to 60 V DC and

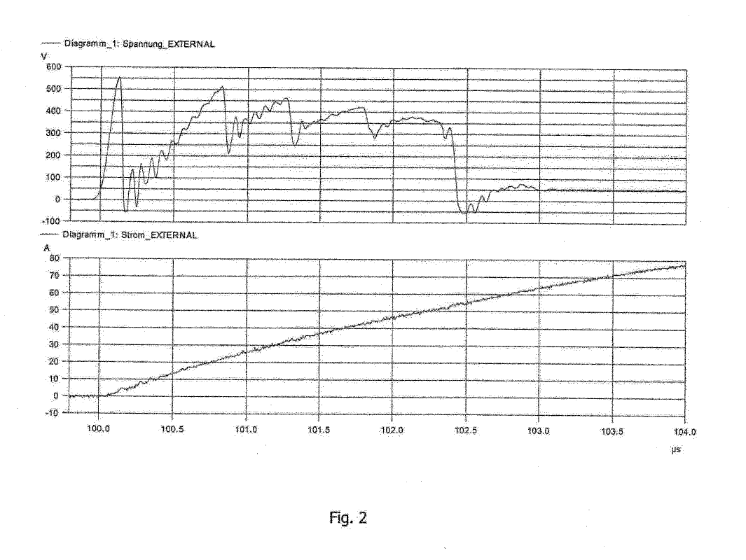

FIG. 2 a diagram of the sequential switching of gas discharge arresters A1 to A5 according to FIG. 1 as well as the respective flow of current over time.

Input terminals −V DC and +V DC can first be recognized from FIG. 1. A series connection of e.g. five gas discharge arresters A1 to A5 are situated between the input terminals. This series connection of five gas discharge arresters results in an arc voltage of approximately 60 V, thereby achieving gas discharge arrester discharge independent of the operating current at operating voltages of up to 60 V.

The capacitors C1 to C4 are connected to the ground potential, or the +V DC terminals respectively, at the connection points of the gas discharge arresters A1 to A5. The capacitance values of these capacitors are for example 100 times that of the capacitance of the gas discharge arresters. What this thereby achieves is the existing input voltage initially being fully applied to gas discharge arrester A5. The gas discharge arrester A5 is therefore enabled upon a specified response voltage being exceeded.

The input voltage is thereafter on the remaining arrangement A1 to A4. The further distribution of the voltage ensues through capacitance of A4 and C3, whereby the same ratio applies as with A5 to C4.

Employing gas discharge arresters A1 to A5 of virtually identical response voltage establishes a sequential connecting of said gas discharge arresters A5 to A1.

The fine protection stage is realized by an antipole series connection of suppressor or TVS diodes V1 to V4, whereby in dimensioning the fine protection, consisting of diodes V1 to V4, the selected stand-off voltage of the diodes is greater than the sum of the arc voltages of the gas discharge arresters A1 to A5, thereby ensuing in the diodes V1 to V4 being discharged subsequent the activation of the gas discharge arresters A5 to A1.

A decoupling impedance L1 is further provided between input terminal −V DC and output terminal −V DC (marked internal).

The inductance of the inductor L1 is thereby to be selected such that when the current rises, there will be a large enough drop in voltage at L1 to enable the gas discharge arresters A1 to A4 before reaching the load limit of the diodes V1 to V4.

The following relationship applies:

$$L 1 = \frac{U}{\frac{d I}{d t}}$$

The example circuit according to FIG. 1 is dimensioned for a similar example operating voltage of 60 V DC.

The following example dimensioning thereby results.

The gas discharge arresters A1 to A5 exhibit a maximum response voltage of 500 V (1 kV/μs). The capacitance of the capacitors C1 to C4 is at approximately 10 nF. The gas discharge arrester capacitance is thereby approximately 1.5 pF.

The TVS diodes V1 to V4 have a stand-off voltage of 30 V. The maximum current carrying capacity amounts to 250 A (10/350 μs). The maximum clamping voltage is approximately 100 V.

Inductance L1 results at a rate of current rise dI/dt=250 A/10 μs: 25 A/μs. The requisite voltage drop in excess of L1 is 500 V−100 V=400 V. Thus resulting in

$$L 1 = \frac{400 V}{25 \frac{A}{µs}} 16 µH$$

Appropriately dimensioning for other operating voltages and other gas discharge arrester capacitance base values are of course also possible without departing from the inventive concept.

1. A circuit arrangement for overload protection in direct current supply circuits of electronic components or devices, particularly telecommunication devices such as transmitting and receiving antennas and/or mobile communication systems, comprising a coarse protection series connection of spark gaps or gas discharge arresters between the input terminals as well as capacitors connected in parallel to the spark gaps or gas discharge arresters, at least one fine protection element between the output terminals and a decoupling impedance between the coarse protection series connection and fine protection element,
characterized in that
the capacitance values of the capacitors are many times greater than the capacitance values of the gas discharge arresters or spark gaps and the inductance of the decoupling impedance is dimensioned such that when the current rises, there will be a large enough drop in voltage in order to connect the spark gaps or gas discharge arresters before the load limit of the fine protection element is reached.

2. The circuit arrangement according to claim 1,
characterized in that
a capacitor is connected between each point of connection of the spark gaps or gas discharge arresters and the ground potential, wherein the ratio of the gas discharge arrester/spark gap capacitance values to the capacitor is essentially 1:100.

3. The circuit arrangement according to claim 1,
characterized in that
the gas discharge arresters have substantially the same response voltage so that upon a surge, the gas discharge arresters can be sequentially enabled.

4. The circuit arrangement according to claim 1,
characterized in that
the fine protection element consists of a series connection of diodes.

5. The circuit arrangement according to claim 4,
characterized in that
the diodes are formed as suppressor diodes or TVS diodes and the stand-off voltage of the diodes of the series connection is greater than the sum of the gas discharge arrester arc voltages.
